(19) United States
(12) Patent Application Publication
(10) Pub. No.: US 2024/0177088 A1
(43) Pub. Date: May 30, 2024

(54) DECIDING SYSTEM FOR STOPPING AND DISPATCHING VEHICLES AND DECIDING METHOD THEREOF

(71) Applicant: Automotive Research & Testing Center, Changhua County (TW)

(72) Inventors: I-Chun KUO, Changhua County (TW); Cheng-Hsien WANG, Changhua County (TW); Tsung-Ming HSU, Changhua County (TW); Ming-Kuan KO, Changhua County (TW)

(21) Appl. No.: 18/058,877

(22) Filed: Nov. 28, 2022

(51) Int. Cl. G06Q 10/06; G06Q 10/02; G06Q 50/30

(52) U.S. Cl. CPC G06Q 10/06314; G06Q 10/02; G06Q 50/30

(57) ABSTRACT

A deciding system for stopping and dispatching vehicles includes a memory and a cloud processing unit. The cloud processing unit is configured to determine one of a fixed vehicle dispatching algorithm and a non-fixed vehicle dispatching algorithm to be executed by the cloud processing unit according to a temporary car-hailing order message; execute the one of the fixed vehicle dispatching algorithm and the non-fixed vehicle dispatching algorithm to generate a stop message corresponding to a stop station according to a dispatch parameter set from the memory, and generate a stop number set corresponding to the first vehicle according to the stop message; and execute the one of the fixed vehicle dispatching algorithm and the non-fixed vehicle dispatching algorithm to generate a dispatch message according to the dispatch parameter set, and generate a dispatch vehicle number set corresponding to the second vehicle according to the dispatch message.

### BACKGROUND

### Technical Field

The present disclosure relates to a deciding system for vehicles and a deciding method thereof. More particularly, the present disclosure relates to a deciding system for stopping and dispatching vehicles and a deciding method thereof.

### Description of Related Art

The frequency of public transportation and the number of passengers in rural areas are generally increased in two time periods: on/off business hours (or on/off school hours). However, at times other than the aforementioned two time periods, there is often only one bus for one hour. Accordingly, if too many passengers wait for the bus, it will cause a lot of waiting time. In addition, the demand is increasing for small and personal short-distance or long-distance logistics and distribution (e.g., LaLaMove). The conventional logistics and distribution management is to transport the goods from the shipper to the logistics center, and then from the logistics center to the collection site. In the conventional logistics and distribution management, there will be cases where the travel paths of the goods overlap in repeated sections, thus taking extra time. Therefore, a deciding system for stopping and dispatching vehicles and a deciding method thereof which are capable of shortening the waiting time, reducing the extra time due to the travel paths overlapping in the repeated sections and realizing the optimal dynamic scheduling of multiple vehicles are commercially desirable.

### SUMMARY

According to one aspect of the present disclosure, a deciding system for stopping and dispatching vehicles is configured to decide stopping and dispatching of the vehicles. The vehicles include a first vehicle and a second vehicle. The deciding system for stopping and dispatching the vehicles includes a first vehicle processing unit, a second vehicle processing unit, a memory and a cloud processing unit. The first vehicle processing unit is disposed on the first vehicle. The second vehicle processing unit is disposed on the second vehicle. The memory stores a dispatch parameter set. The cloud processing unit is signally connected to the first vehicle processing unit, the second vehicle processing unit and the memory. The cloud processing unit receives the dispatch parameter set and is configured to perform a deciding method for stopping and dispatching the vehicles, and the deciding method for stopping and dispatching the vehicles includes performing an algorithm deciding step, a vehicle stop deciding step, a vehicle dispatch deciding step and a message transmitting step. The algorithm deciding step is performed to determine one of a fixed vehicle dispatching algorithm and a non-fixed vehicle dispatching algorithm to be executed by the cloud processing unit according to a temporary car-hailing order message. The vehicle stops deciding step is performed to execute the one of the fixed vehicle dispatching algorithm and the non-fixed vehicle dispatching algorithm to generate a stop message corresponding to a stop station according to the dispatch parameter set, and generate a stop number set corresponding to the first vehicle according to the stop message. The vehicle dispatch deciding step is performed to execute the one of the fixed vehicle dispatching algorithm and the non-fixed vehicle dispatching algorithm to generate a dispatch message according to the dispatch parameter set, and generate a dispatch vehicle number set corresponding to the second vehicle according to the dispatch message. The message transmitting step is performed to transmit the stop number set and the dispatch vehicle number set to the first vehicle processing unit and the second vehicle processing unit, respectively.

According to another aspect of the present disclosure, a deciding method for stopping and dispatching vehicles is configured to decide stopping and dispatching of the vehicles. The vehicles include a first vehicle and a second vehicle, and the deciding method for stopping and dispatching the vehicles includes performing an algorithm deciding step, a vehicle stop deciding step, a vehicle dispatch deciding step and a message transmitting step. The algorithm deciding step is performed to configure a cloud processing unit to determine one of a fixed vehicle dispatching algorithm and a non-fixed vehicle dispatching algorithm to be executed by the cloud processing unit according to a temporary car-hailing order message. The vehicle stops deciding step is performed to configure the cloud processing unit to execute the one of the fixed vehicle dispatching algorithm and the non-fixed vehicle dispatching algorithm to generate a stop message corresponding to a stop station according to a dispatch parameter set from a memory, and generate a stop number set corresponding to the first vehicle according to the stop message. The vehicle dispatch deciding step is performed to configure the cloud processing unit to execute the one of the fixed vehicle dispatching algorithm and the non-fixed vehicle dispatching algorithm to generate a dispatch message according to the dispatch parameter set, and generate a dispatch vehicle number set corresponding to the second vehicle according to the dispatch message. The message transmitting step is performed to configure the cloud processing unit to transmit the stop number set and the dispatch vehicle number set to a first vehicle processing unit and a second vehicle processing unit, respectively. The first vehicle processing unit is disposed on the first vehicle, and the second vehicle processing unit is disposed on the second vehicle.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a deciding system for stopping and dispatching vehicles according to a first embodiment of the present disclosure.

FIG. 2 shows a flow chart of a deciding method for stopping and dispatching vehicles according to a second embodiment of the present disclosure.

FIG. 3 shows a schematic view of the deciding system for stopping and dispatching the vehicles of FIG. 1 applied to fixed route transportation.

FIG. 4 shows a flow chart of a fixed vehicle dispatching algorithm of FIG. 3.

FIG. 5 shows a schematic view of a scene of a fixed vehicle dispatch of the present disclosure.

FIG. 6 shows a schematic view of the deciding system for stopping and dispatching the vehicles of FIG. 1 applied to non-fixed route transportation.

FIG. 7 shows a flow chart of a non-fixed vehicle dispatching algorithm of FIG. 6.

FIG. 8 shows a schematic view of a scene of a non-fixed vehicle dispatch of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

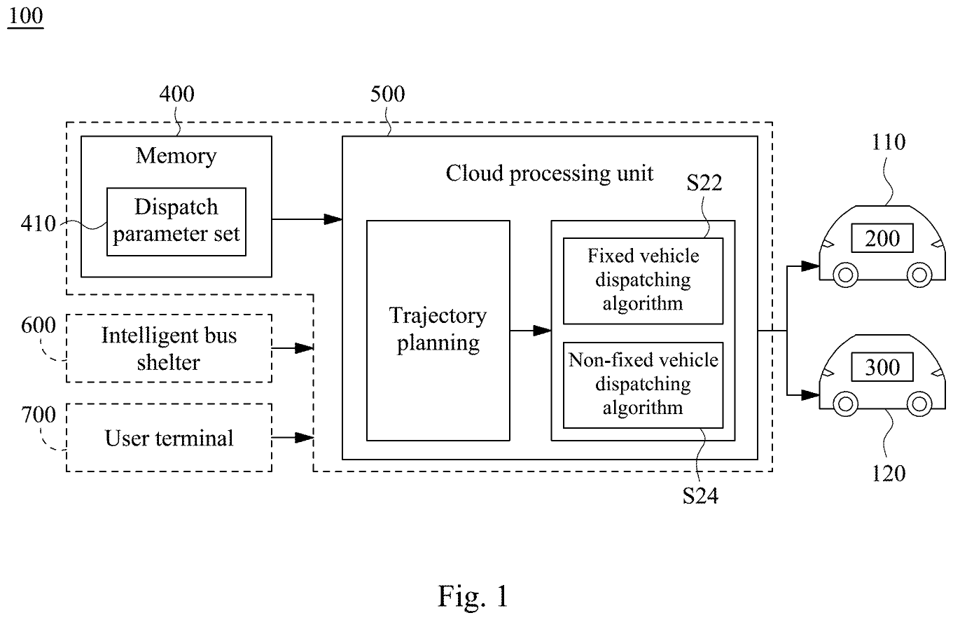

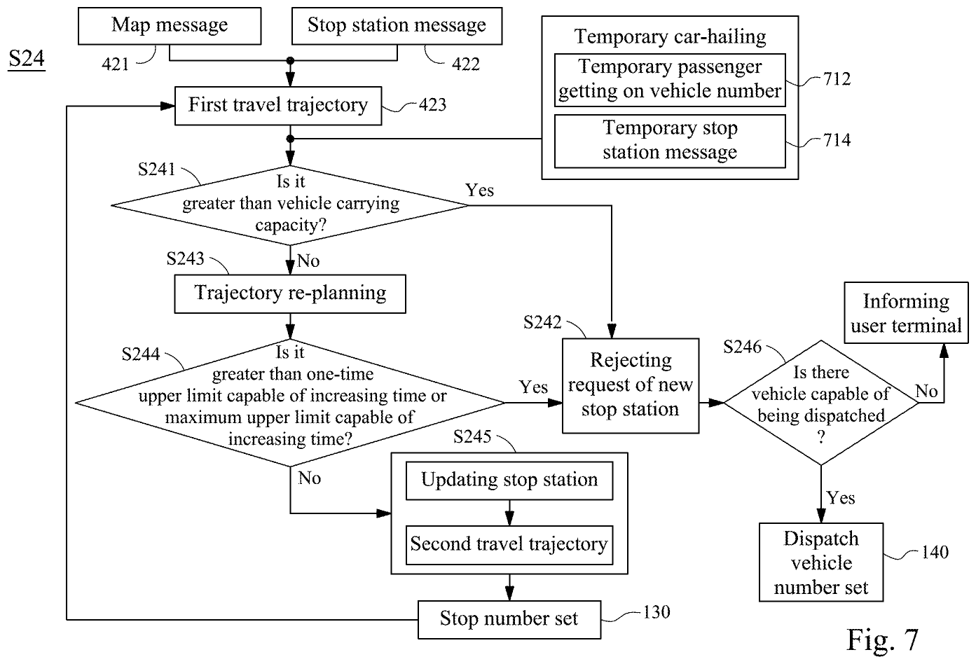

Reference is made to FIG. 1. FIG. 1 shows a schematic view of a deciding system 100 for stopping and dispatching vehicles according to a first embodiment of the present disclosure. The deciding system 100 for stopping and dispatching the vehicles is configured to decide stopping and dispatching of the vehicles. The vehicles include a first vehicle 110 and a second vehicle 120. The deciding system 100 for stopping and dispatching the vehicles includes a first vehicle processing unit 200, a second vehicle processing unit 300, a memory 400 and a cloud processing unit 500. The first vehicle processing unit 200 is disposed on the first vehicle 110. The second vehicle processing unit 300 is disposed on the second vehicle 120. The memory 400 stores a dispatch parameter set 410. The cloud processing unit 500 is signally connected to the first vehicle processing unit 200, the second vehicle processing unit 300 and the memory 400. The cloud processing unit 500 receives the dispatch parameter set 410 and is configured to perform a deciding method for stopping and dispatching the vehicles. The deciding method for stopping and dispatching the vehicles includes trajectory planning, a fixed vehicle dispatching algorithm S22 and a non-fixed vehicle dispatching algorithm S24. The trajectory planning may include collecting a map message (e.g., the map message 421 in FIG. 7) and a stop station message (e.g., the stop station message 422 in FIG. 7), and planning a travel trajectory (e.g., a first travel trajectory 423 in FIG. 7) according to the map message and the stop station message.

In one embodiment, the deciding system 100 for stopping and dispatching the vehicles can further include an intelligent bus shelter 600 and a user terminal 700. The intelligent bus shelter 600 is signally connected to the cloud processing unit 500 and located at a stop station. The intelligent bus shelter 600 is configured to detect a vehicle passenger number (the number of people waiting) of the dispatch parameter set 410 and transmit the vehicle passenger number to the cloud processing unit 500. The intelligent bus shelter 600 may include a camera or a mobile device, but the present disclosure is not limited thereto. The user terminal 700 is signally connected to the cloud processing unit 500 and has an application program (APP). The application program is configured to generate the temporary car-hailing order message and transmit the temporary car-hailing order message to the cloud processing unit 500.

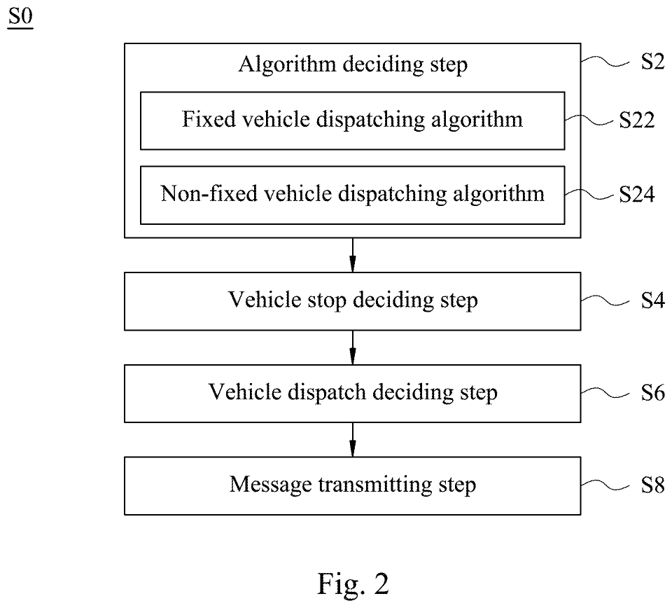

Reference is made to FIGS. 1 and 2. FIG. 2 shows a flow chart of a deciding method S0 for stopping and dispatching vehicles according to a second embodiment of the present disclosure. The deciding method S0 for stopping and dispatching the vehicles includes performing an algorithm deciding step S2, a vehicle stop deciding step S4, a vehicle dispatch deciding step S6 and a message transmitting step S8. The algorithm deciding step S2 is performed to configure the cloud processing unit 500 to determine one of a fixed vehicle dispatching algorithm S22 and a non-fixed vehicle dispatching algorithm S24 to be executed by the cloud processing unit 500 according to a temporary car-hailing order message. The vehicle stops deciding step S4 is performed to configure the cloud processing unit 500 to execute the one of the fixed vehicle dispatching algorithm S22 and the non-fixed vehicle dispatching algorithm S24 to generate a stop message corresponding to a stop station according to a dispatch parameter set 410 from the memory 400, and generate a stop number set corresponding to the first vehicle 110 according to the stop message. The vehicle dispatch deciding step S6 is performed to configure the cloud processing unit 500 to execute the one of the fixed vehicle dispatching algorithm S22 and the non-fixed vehicle dispatching algorithm S24 to generate a dispatch message according to the dispatch parameter set 410, and generate a dispatch vehicle number set corresponding to the second vehicle 120 according to the dispatch message. The message transmitting step S8 is performed to configure the cloud processing unit 500 to transmit the stop number set and the dispatch vehicle number set to the first vehicle processing unit 200 and the second vehicle processing unit 300, respectively.

Therefore, the deciding system 100 for stopping and dispatching the vehicles of the present disclosure can be applied to fixed route transportation or non-fixed route transportation and can adjust the flow of passengers of each vehicle and each stop station to achieve the maximum carrying capacity. Moreover, the present disclosure can effectively reduce the waiting time of passengers on each route by dispatching.

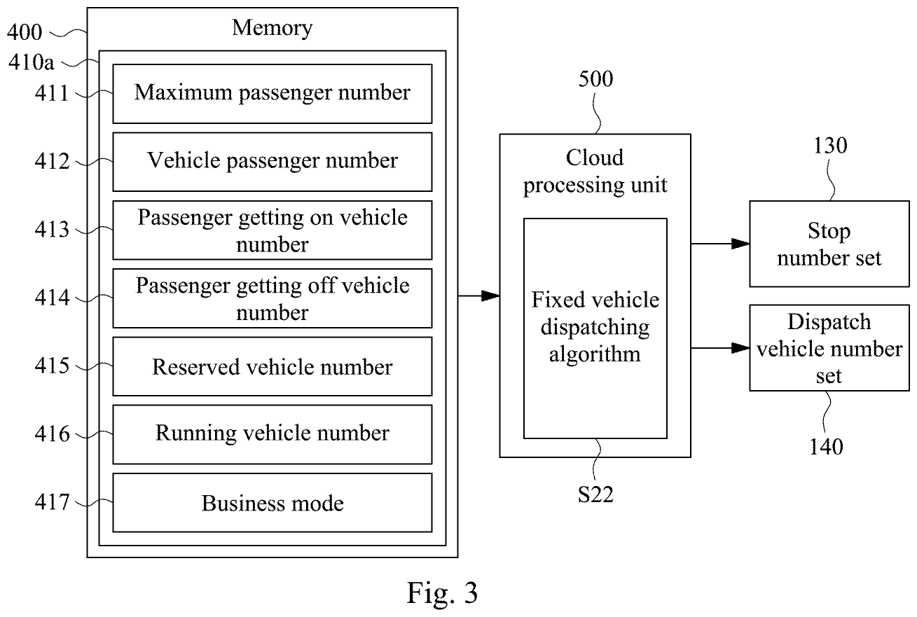

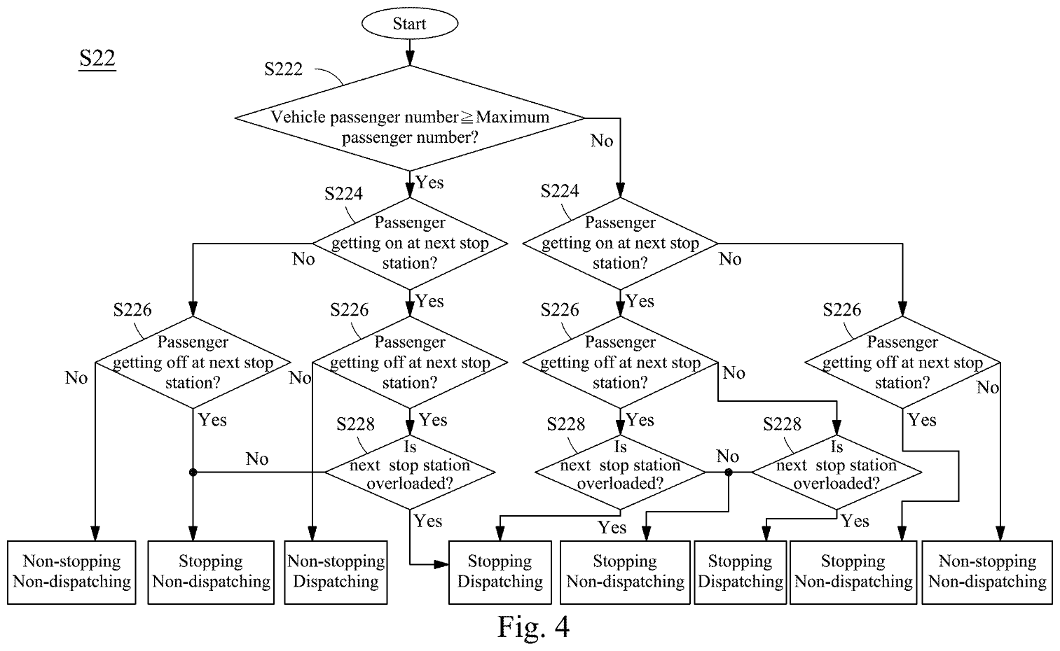

Reference is made to FIGS. 1, 2, 3 and 4. FIG. 3 shows a schematic view of the deciding system 100 for stopping and dispatching the vehicles of FIG. 1 applied to fixed route transportation. FIG. 4 shows a flow chart of a fixed vehicle dispatching algorithm S22 of FIG. 3. The memory 400 stores a dispatch parameter set 410a. The dispatch parameter set 410a includes a maximum passenger number 411, a vehicle passenger number 412, a passenger getting on vehicle number 413, a passenger getting off vehicle number 414, a reserved vehicle number 415, a running vehicle number 416 and a business mode 417. The maximum passenger number 411 represents a vehicle carrying capacity (the total number of seats). The vehicle passenger number 412 represents the current number of passengers on the first vehicle 110. The passenger getting on vehicle number 413 represents the number of passengers getting on at each stop station. The passenger getting off vehicle number 414 represents the number of passengers getting off at each stop station. The reserved vehicle number 415 represents the number of the second vehicles 120. The running vehicle number 416 represents the number of the first vehicles 110. The business mode 417 is one of “fixed route transportation” and “non-fixed route transportation”. The fixed vehicle dispatching algorithm S22 includes performing a remaining seat confirmation step S222, a passenger boarding confirmation step S224, a passenger alighting confirmation step S226 and a vehicle overload confirmation step S228.

The remaining seat confirmation step S222 is “Vehicle passenger number Maximum passenger number?”, and includes confirming whether the vehicle passenger number 412 is greater than or equal to the maximum passenger number 411, and then generating a first confirmation result. The passenger boarding confirmation step S224 is “Passenger getting on at next stop station?”, and includes confirming whether there is at least one passenger getting on at a next stop station where the first vehicle 110 is located, and then generating a second confirmation result. The passenger alighting confirmation step S226 is “Passenger getting off at next stop station?”, and includes confirming whether there is the at least one passenger getting off at the next stop station where the first vehicle 110 is located, and then generating a third confirmation result. The vehicle overload confirmation step S228 is “Is next stop station overloaded?” and includes confirming whether the vehicle passenger number 412 minus the passenger getting off vehicle number 414 plus the passenger getting on vehicle number 413 is greater than the maximum passenger number 411, and then generating a fourth confirmation result. In other words, the vehicle overload confirmation step S228 is “((Vehicle passenger number)−(passenger getting off vehicle number)+(passenger getting on vehicle number))>maximum passenger number?”.

The stop message and the dispatch message are determined according to at least three of the first confirmation result, the second confirmation result, the third confirmation result and the fourth confirmation result. In detail, in response to determining that the first confirmation result is yes, the second confirmation result is yes, the third confirmation result is yes and the fourth confirmation result is yes, the stop message and the dispatch message represent a stop operation (Stopping) and a dispatch operation (Dispatching), respectively. In response to determining that the first confirmation result is yes, the second confirmation result is yes, the third confirmation result is yes and the fourth confirmation result is no, the stop message and the dispatch message represent the stop operation (Stopping) and a non-dispatch operation (Non-dispatching), respectively. In response to determining that the first confirmation result is yes, the second confirmation result is yes and the third confirmation result is no, the stop message and the dispatch message represent a non-stop operation (Non-stopping) and the dispatch operation (Dispatching), respectively. In response to determining that the first confirmation result is yes, the second confirmation result is no and the third confirmation result is yes, the stop message and the dispatch message represent the stop operation (Stopping) and the non-dispatch operation (Non-dispatching), respectively. In response to determining that the first confirmation result is yes, the second confirmation result is no and the third confirmation result is no, the stop message and the dispatch message represent the non-stop operation (Non-stopping) and the non-dispatch operation (Non-dispatching), respectively. In addition, in response to determining that the first confirmation result is no, the second confirmation result is yes, the third confirmation result is yes and the fourth confirmation result is yes, the stop message and the dispatch message represent the stop operation (Stopping) and the dispatch operation (Dispatching), respectively. In response to determining that the first confirmation result is no, the second confirmation result is yes, the third confirmation result is yes and the fourth confirmation result is no, the stop message and the dispatch message represent the stop operation (Stopping) and the non-dispatch operation (Non-dispatching), respectively. In response to determining that the first confirmation result is no, the second confirmation result is yes, the third confirmation result is no and the fourth confirmation result is yes, the stop message and the dispatch message represent the stop operation (Stopping) and the dispatch operation (Dispatching), respectively. In response to determining that the first confirmation result is no, the second confirmation result is yes, the third confirmation result is no and the fourth confirmation result is no, the stop message and the dispatch message represent the stop operation (Stopping) and the non-dispatch operation (Non-dispatching), respectively. In response to determining that the first confirmation result is no, the second confirmation result is no and the third confirmation result is yes, the stop message and the dispatch message represent the stop operation (Stopping) and the non-dispatch operation (Non-dispatching), respectively. In response to determining that the first confirmation result is no, the second confirmation result is no and the third confirmation result is no, the stop message and the dispatch message represent the non-stop operation (Non-stopping) and the non-dispatch operation (Non-dispatching), respectively. “Stop operation” represents that the first vehicle processing unit 200 controls displacement of the first vehicle 110 according to the stop number set 130, thereby stopping the first vehicle 110 at the corresponding stop station (the next stop station). “Dispatch operation” represents that the second vehicle processing unit 300 controls displacement of the second vehicle 120 according to the dispatch vehicle number set 140, thereby dispatching the second vehicle 120 to the corresponding stop station (the next stop station). “Non-stop operation” represents that the first vehicle 110 is not stopped at the stop station. “Non-dispatch operation” represents that the second vehicle 120 is not dispatched to the stop station. The deciding of the present disclosure is described below by a scene description.

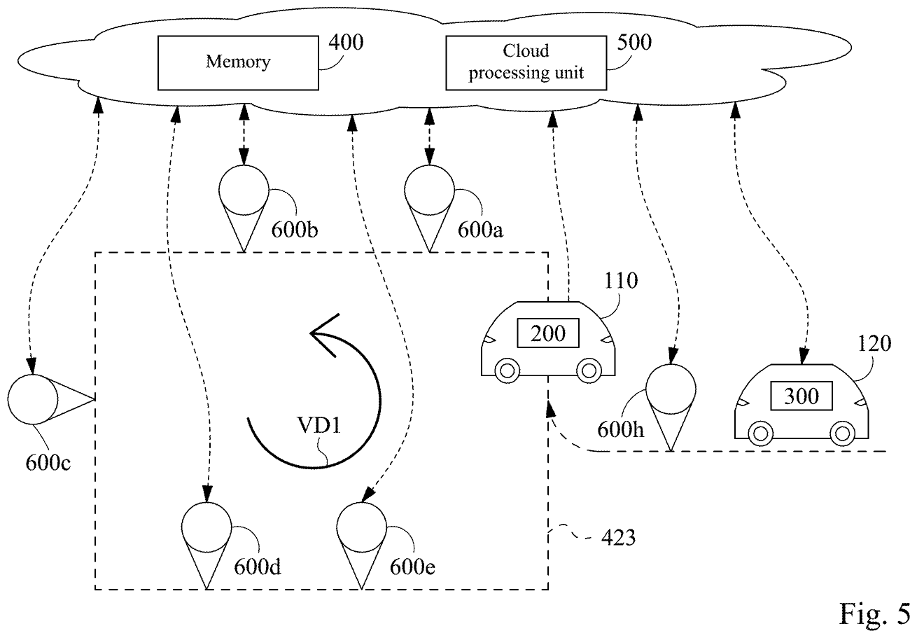

Reference is made to FIGS. 3, 4 and 5. FIG. 5 shows a schematic view of a scene of a fixed vehicle dispatch of the present disclosure. The fixed vehicle dispatch is used for the fixed route transportation and is a fixed-point stop. The fixed vehicle dispatch may be applied to a rural transportation (e.g., a bus). In the scene, the deciding system 100 for stopping and dispatching the vehicles includes a plurality of intelligent bus shelters 600a, 600b, 600c, 600d, 600e and a host station 600h. The first vehicle 110 is located between the host station 600h and the intelligent bus shelter 600a. The first vehicle 110 is moved along a vehicle traveling direction VD1 and the first travel trajectory 423. The cloud processing unit 500 does not receive a temporary car-hailing order message and decides to perform the fixed vehicle dispatching algorithm S22. In other words, in the algorithm deciding step S2, before the cloud processing unit 500 receives the temporary car-hailing order message, the cloud processing unit 500 performs the fixed vehicle dispatching algorithm S22. Each of the intelligent bus shelters 600a, 600b, 600c, 600d, 600e is signally connected to the cloud processing unit 500 and located at each stop station. Each of the intelligent bus shelters 600a, 600b, 600c, 600d, 600e is configured to detect each of the passenger getting on vehicle numbers 413 of the dispatch parameter set 410a and transmit the each of the passenger getting on vehicle numbers 413 to the cloud processing unit 500.

In a first example of the fixed vehicle dispatch, for the dispatch parameter set 410a, it is assumed that the maximum passenger number 411 is 15; the vehicle passenger number 412 is 9; the passenger getting on vehicle number 413 is 3; the passenger getting off vehicle number 414 is 0; the reserved vehicle number 415 is 1; the running vehicle number 416 is 1; and the business mode 417 is “fixed route transportation” which represents that the first vehicle 110 departs at a fixed time on a fixed schedule. Even if no passenger is on the first vehicle 110 at the departure time, the first vehicle 110 still depart at the departure time as usual, and the host station 600h is a start station and an end station. Under the condition of the above-mentioned dispatch parameter set 410a, in the fixed vehicle dispatching algorithm S22, the remaining seat confirmation step S222 is performed to confirm whether the vehicle passenger number 412 is greater than or equal to the maximum passenger number 411, and then generate the first confirmation result. The first confirmation result is no (i.e., the vehicle passenger number 412 (9 passengers) is smaller than the maximum passenger number 411 (15 passengers)). The passenger boarding confirmation step S224 is performed to confirm whether there is at least one passenger getting on at the next stop station (i.e., the intelligent bus shelter 600a) where the first vehicle 110 is located, and then generate the second confirmation result. The second confirmation result is yes (i.e., the passenger getting on vehicle number 413 is 3 which represents that there are 3 passengers who want to get on the first vehicle 110 at the next stop station). The passenger alighting confirmation step S226 is performed to confirm whether there is at least one passenger getting off at the next stop station where the first vehicle 110 is located, and then generate the third confirmation result. The third confirmation result is no (i.e., the passenger getting off vehicle number 414 is 0 which represents that there is no passenger who wants to get off the first vehicle 110 at the next stop station). The vehicle overload confirmation step S228 is performed to confirm whether the vehicle passenger number 412 minus the passenger getting off vehicle number 414 plus the passenger getting on vehicle number 413 is greater than the maximum passenger number 411, and then generate the fourth confirmation result. The fourth confirmation result is no (i.e., the value of 12 passengers (9-0+3) is smaller than the maximum passenger number 411 (15 passengers)). As the result, in response to determining that the first confirmation result is no, the second confirmation result is yes, the third confirmation result is no and the fourth confirmation result is no, the stop message and the dispatch message represent the stop operation (Stopping) and the non-dispatch operation (Non-dispatching), respectively. In other words, the first vehicle 110 is stopped at the intelligent bus shelter 600a, and the second vehicle 120 is not dispatched to the intelligent bus shelter 600a.

In a second example of the fixed vehicle dispatch, for the dispatch parameter set 410a, it is assumed that the maximum passenger number 411 is 15; the vehicle passenger number 412 is 9; the passenger getting on vehicle number 413 is 8; the passenger getting off vehicle number 414 is 1; the reserved vehicle number 415 is 1; the running vehicle number 416 is 1; and the business mode 417 is “fixed route transportation”. Under the condition of the above-mentioned dispatch parameter set 410a, in the fixed vehicle dispatching algorithm S22, the remaining seat confirmation step S222 is performed to confirm whether the vehicle passenger number 412 is greater than or equal to the maximum passenger number 411, and then generate the first confirmation result. The first confirmation result is no (i.e., the vehicle passenger number 412 (9 passengers) is smaller than the maximum passenger number 411 (15 passengers)). The passenger boarding confirmation step S224 is performed to confirm whether there is at least one passenger getting on at the next stop station (i.e., the intelligent bus shelter 600a) where the first vehicle 110 is located, and then generate the second confirmation result. The second confirmation result is yes (i.e., the passenger getting on vehicle number 413 is 8 which represents that there are 8 passengers who want to get on the first vehicle 110 at the next stop station). The passenger alighting confirmation step S226 is performed to confirm whether there is at least one passenger getting off at the next stop station where the first vehicle 110 is located, and then generate the third confirmation result. The third confirmation result is yes (i.e., the passenger getting off vehicle number 414 is 1 which represents that there is 1 passenger who wants to get off the first vehicle 110 at the next stop station). The vehicle overload confirmation step S228 is performed to confirm whether the vehicle passenger number 412 minus the passenger getting off vehicle number 414 plus the passenger getting on vehicle number 413 is greater than the maximum passenger number 411, and then generate the fourth confirmation result. The fourth confirmation result is yes (i.e., the value of 16 passengers (9−1+8) is greater than the maximum passenger number 411 (15 passengers)). As the result, in response to determining that the first confirmation result is no, the second confirmation result is yes, the third confirmation result is yes and the fourth confirmation result is yes, the stop message and the dispatch message represent the stop operation (Stopping) and the dispatch operation (Dispatching), respectively. In other words, the first vehicle 110 is stopped at the intelligent bus shelter 600a, and the second vehicle 120 is dispatched to the intelligent bus shelter 600a.

In a third example of the fixed vehicle dispatch, for the dispatch parameter set 410a, it is assumed that the maximum passenger number 411 is 15; the vehicle passenger number 412 is 15; the passenger getting on vehicle number 413 is 8; the passenger getting off vehicle number 414 is 0; the reserved vehicle number 415 is 1; the running vehicle number 416 is 1; and the business mode 417 is “fixed route transportation”. Under the condition of the above-mentioned dispatch parameter set 410a, in the fixed vehicle dispatching algorithm S22, the remaining seat confirmation step S222 is performed to confirm whether the vehicle passenger number 412 is greater than or equal to the maximum passenger number 411, and then generate the first confirmation result. The first confirmation result is yes (i.e., the vehicle passenger number 412 (15 passengers) is equal to the maximum passenger number 411 (15 passengers)). The passenger boarding confirmation step S224 is performed to confirm whether there is at least one passenger getting on at the next stop station (i.e., the intelligent bus shelter 600a) where the first vehicle 110 is located, and then generate the second confirmation result. The second confirmation result is yes (i.e., the passenger getting on vehicle number 413 is 8 which represents that there are 8 passengers who want to get on the first vehicle 110 at the next stop station). The passenger alighting confirmation step S226 is performed to confirm whether there is at least one passenger getting off at the next stop station where the first vehicle 110 is located, and then generate the third confirmation result. The third confirmation result is no (i.e., the passenger getting off vehicle number 414 is 0 which represents that there is no passenger who wants to get off the first vehicle 110 at the next stop station). The vehicle overload confirmation step S228 is performed to confirm whether the vehicle passenger number 412 minus the passenger getting off vehicle number 414 plus the passenger getting on vehicle number 413 is greater than the maximum passenger number 411, and then generate the fourth confirmation result. The fourth confirmation result is yes (i.e., the value of 23 passengers (15-0+8) is greater than the maximum passenger number 411 (15 passengers)). As the result, in response to determining that the first confirmation result is yes, the second confirmation result is yes and the third confirmation result is no (regardless of the fourth confirmation result), the stop message and the dispatch message represent the non-stop operation (Non-stopping) and the dispatch operation (Dispatching), respectively. In other words, the first vehicle 110 is not stopped at the intelligent bus shelter 600a, and the second vehicle 120 is dispatched to the intelligent bus shelter 600a.

Therefore, the deciding system 100 for stopping and dispatching the vehicles and the deciding method S0 thereof of the present disclosure can be applied to the fixed route transportation and can adjust the flow of the passengers of each vehicle and each stop station to achieve the maximum carrying capacity. Moreover, the present disclosure can effectively reduce the waiting time of the passengers on each route by dispatching.

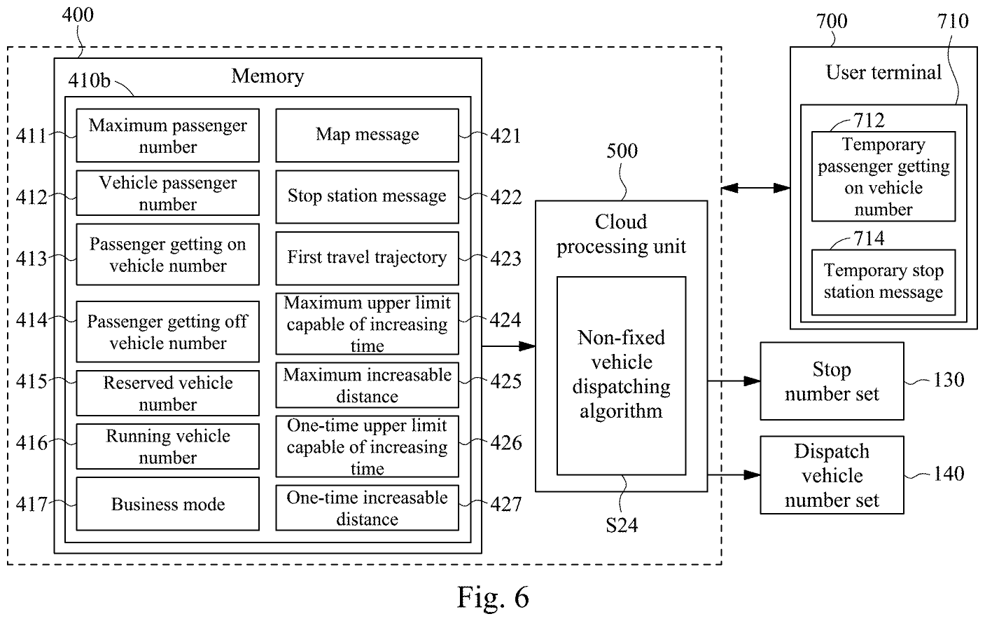

Reference is made to FIGS. 1, 2, 6 and 7. FIG. 6 shows a schematic view of the deciding system 100 for stopping and dispatching the vehicles of FIG. 1 applied to non-fixed route transportation. FIG. 7 shows a flow chart of a non-fixed vehicle dispatching algorithm S24 of FIG. 6. The memory 400 stores a dispatch parameter set 410b. The dispatch parameter set 410b includes a maximum passenger number 411, a vehicle passenger number 412, a passenger getting on vehicle number 413, a passenger getting off vehicle number 414, a reserved vehicle number 415, a running vehicle number 416, an business mode 417, a map message 421, a stop station message 422, a first travel trajectory 423, a maximum upper limit 424 capable of increasing time, a maximum increasable distance 425, a one-time upper limit 426 capable of increasing time and a one-time increasable distance 427. The map message 421 represents a map covering all vehicle travel trajectories. The stop station message 422 represents a message of at least one stop station where the first vehicle 110 is stopped. The first travel trajectory 423 represents an initial travel trajectory of the first vehicle 110. The maximum upper limit 424 capable of increasing time represents an upper limit capable of increasing time when the first vehicle 110 travels along all temporary stop stations. The maximum increasable distance 425 represents the maximum upper limit 424 capable of increasing time multiplied by a speed of the first vehicle 110. The one-time upper limit 426 capable of increasing time represents an upper limit capable of increasing time when the first vehicle 110 travels along a single temporary stop station. The one-time increasable distance 427 represents the one-time upper limit 426 capable of increasing time multiplied by the speed of the first vehicle 110. In addition, the deciding system 100 for stopping and dispatching the vehicles further includes a user terminal 700. The user terminal 700 is signally connected to the cloud processing unit 500 and has an application program. The application program is configured to generate the temporary car-hailing order message 710 and transmit the temporary car-hailing order message 710 to the cloud processing unit 500. The temporary car-hailing order message 710 includes at least one temporary passenger getting on vehicle number 712 and at least one temporary stop station message 714, and the first vehicle 110 is moved according to the first travel trajectory 423. The first travel trajectory 423 can be obtained from the map message 421 and the stop station message 422.

In response to determining that the cloud processing unit 500 receives the temporary car-hailing order message 710 from the user terminal 700, the cloud processing unit 500 performs the non-fixed vehicle dispatching algorithm S24. The non-fixed vehicle dispatching algorithm S24 includes an overload confirmation step S241, a new stop station rejecting step S242, a trajectory re-planning step S243, a time-out confirmation step S244, a stop station updating step S245 and a dispatch vehicle confirmation step S246.

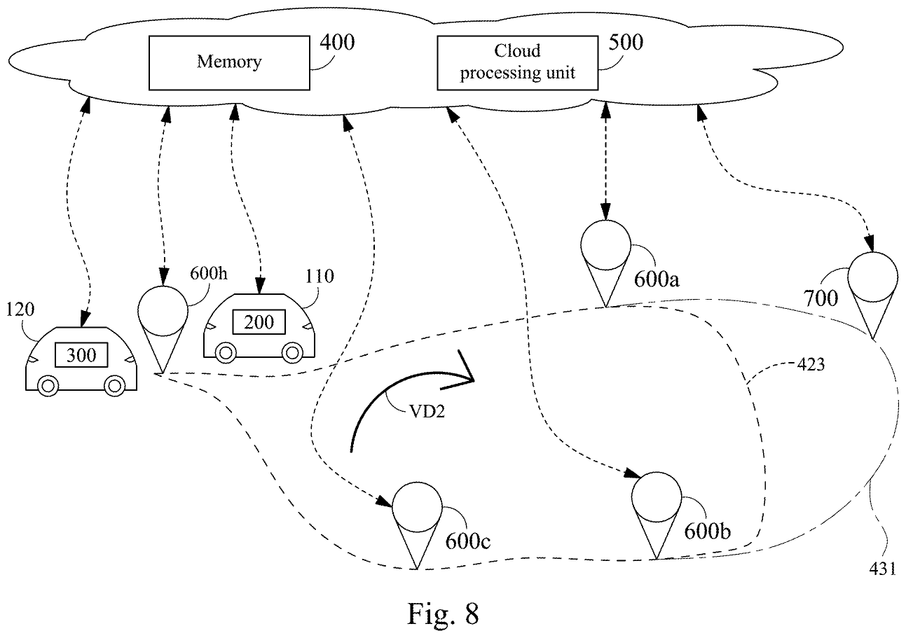

The overload confirmation step S241 is “Is it greater than vehicle carrying capacity?”, and includes confirming whether a sum of the at least one temporary passenger getting on vehicle number 712 and the passenger getting on vehicle number 413 is greater than the maximum passenger number 411 of the first vehicle 110, and then generating an overload confirmation result. The new stop station rejecting step S242 includes rejecting a request of a new stop station. The trajectory re-planning step S243 is “Trajectory re-planning”, and includes re-planning a travel path of the first vehicle 110 to generate a second travel trajectory according to the first travel trajectory 423 and the at least one temporary stop station message 714. There is a trajectory difference 431 (shown in FIG. 8) between the second travel trajectory and the first travel trajectory 423. The time-out confirmation step S244 is “Is it greater than one-time upper limit capable of increasing time or maximum upper limit capable of increasing time?”, and includes confirming whether a one-time travel increasing time of the first vehicle 110 caused by the trajectory difference 431 is greater than the one-time upper limit 426 capable of increasing time, and confirming whether a total travel increasing time of the first vehicle 110 caused by the trajectory difference 431 is greater than the maximum upper limit 424 capable of increasing time, thereby generating a time-out confirmation result. The stop station updating step S245 includes updating the stop station to generate an updated stop station (Updating stop station) according to the at least one temporary stop station message 714, and generating the stop number set 130, so that the updated stop station corresponds to the second travel trajectory. In response to determining that the overload confirmation result is no and the time-out confirmation result is no, the stop station updating step S245 is performed. In response to determining that the overload confirmation result is yes, the new stop station rejecting step S242 is performed. In response to determining that the overload confirmation result is no and the time-out confirmation result is yes, the new stop station rejecting step S242 is performed. The dispatch vehicle confirmation step S246 is “Is there vehicle capable of being dispatched?”, and includes confirming whether there is the second vehicle 120 that is capable of being dispatched, and then generating a dispatch vehicle confirmation result. In response to determining that the dispatch vehicle confirmation result is yes, the dispatch message represents the dispatch operation, and the dispatch vehicle number set 140 is generated. In response to determining that the dispatch vehicle confirmation result is no, the dispatch message represents the non-dispatch operation and is transmitted to the user terminal 700 (Informing the user terminal 700). The deciding of the present disclosure is described below by a scene description.

Reference is made to FIGS. 6, 7 and 8. FIG. 8 shows a schematic view of a scene of a non-fixed vehicle dispatch of the present disclosure. The non-fixed vehicle dispatch is used for dynamic routes and may be applied to a healthy bus or a Demand Responsive Transport System (DRTS). In the scene, the deciding system 100 for stopping and dispatching the vehicles includes a plurality of intelligent bus shelters 600a, 600b, 600c, a host station 600h and a user terminal 700. The first vehicle 110 departs from the host station 600h and is moved along a vehicle traveling direction VD2 and the first travel trajectory 423. The cloud processing unit 500 originally performs the fixed vehicle dispatching algorithm S22. The cloud processing unit 500 receives a temporary car-hailing order message 710 and decides to perform the non-fixed vehicle dispatching algorithm S24. In other words, in the algorithm deciding step S2, after the cloud processing unit 500 receives the temporary car-hailing order message 710, the cloud processing unit 500 performs an algorithm which is switched from the fixed vehicle dispatching algorithm S22 to the non-fixed vehicle dispatching algorithm S24. Each of the intelligent bus shelters 600a, 600b, 600c is signally connected to the cloud processing unit 500 and located at each stop station. Each of the intelligent bus shelters 600a, 600b, 600c is configured to detect each of the passenger getting on vehicle numbers 413 of the dispatch parameter set 410b and transmit the each of the passenger getting on vehicle numbers 413 to the cloud processing unit 500.

In a first example of the non-fixed vehicle dispatch, it is assumed that the first vehicle 110 is originally moved along the first travel trajectory 423. For the dispatch parameter set 410b, the maximum passenger number 411 is 15; the vehicle passenger number 412 is 0; the passenger getting on vehicle number 413 of the intelligent bus shelter 600a is 3; the passenger getting on vehicle number 413 of the intelligent bus shelter 600b is 1; the passenger getting on vehicle number 413 of the intelligent bus shelter 600c is 2; the passenger getting off vehicle number 414 of each of the intelligent bus shelters 600a, 600b, 600c is 0; the reserved vehicle number 415 is 1; the running vehicle number 416 is 1; the business mode 417 is “non-fixed route transportation”; the maximum upper limit 424 capable of increasing time is 10 minutes; and the one-time upper limit 426 capable of increasing time is 3 minutes. The temporary passenger getting on vehicle number 712 of the temporary car-hailing order message 710 is 2, and the temporary stop station message 714 corresponds to the location of the user terminal 700. The one-time travel increasing time and the total travel increasing time are both 2 minutes. Under the conditions of the above-mentioned dispatch parameter set 410b, the temporary car-hailing order message 710 and travel increasing times, in the non-fixed vehicle dispatching algorithm S24, the overload confirmation step S241 is performed to confirm whether the sum of the temporary passenger getting on vehicle number 712 and the passenger getting on vehicle number 413 is greater than the maximum passenger number 411 of the first vehicle 110, and then generate the overload confirmation result. The overload confirmation result is no (i.e., the sum (8 passengers) of the temporary passenger getting on vehicle number 712 (2 passengers) and the passenger getting on vehicle number 413 (6 passengers) at all of the intelligent bus shelters 600a, 600b, 600c is not greater than the maximum passenger number 411 (15 passengers)). In response to determining that the overload confirmation result is no, the trajectory re-planning step S243 and the time-out confirmation step S244 are performed. The trajectory re-planning step S243 is performed to re-plan the travel path of the first vehicle 110 to generate the second travel trajectory according to the first travel trajectory 423 and the temporary stop station message 714. There is the trajectory difference 431 between the second travel trajectory and the first travel trajectory 423. The time-out confirmation step S244 is performed to confirm whether the one-time travel increasing time of the first vehicle 110 caused by the trajectory difference 431 is greater than the one-time upper limit 426 capable of increasing time, and confirm whether the total travel increasing time of the first vehicle 110 caused by the trajectory difference 431 is greater than the maximum upper limit 424 capable of increasing time, thereby generating the time-out confirmation result. Because the one-time travel increasing time and the total travel increasing time are both 2 minutes, the time-out confirmation result is no. In response to determining that the time-out confirmation result is no, the new stop station rejecting step S242 and the dispatch vehicle confirmation step S246 are not performed, and the stop station updating step S245 is performed. The stop station updating step S245 is performed to update the stop station to generate the updated stop station according to the temporary stop station message 714, and generate the stop number set 130 (i.e., the stop number set 130 corresponds to the intelligent bus shelter 600a, the user terminal 700, the intelligent bus shelter 600b and the intelligent bus shelter 600c in sequence according to the vehicle traveling direction VD2), so that the updated stop station (i.e., the new stop station of the user terminal 700) corresponds to the second travel trajectory.

In a second example of the non-fixed vehicle dispatch, it is assumed that the first vehicle 110 is originally moved along the first travel trajectory 423. The dispatch parameter set 410b and the temporary car-hailing order message 710 are the same as the dispatch parameter set 410b and the temporary car-hailing order message 710 of the first example, respectively. The one-time travel increasing time and the total travel increasing time are both 7 minutes. Under the conditions of the above-mentioned dispatch parameter set 410b, the temporary car-hailing order message 710 and travel increasing times, in the non-fixed vehicle dispatching algorithm S24, the overload confirmation step S241 is performed to confirm whether the sum of the temporary passenger getting on vehicle number 712 and the passenger getting on vehicle number 413 is greater than the maximum passenger number 411 of the first vehicle 110, and then generate the overload confirmation result. The overload confirmation result is no. In response to determining that the overload confirmation result is no, the trajectory re-planning step S243 and the time-out confirmation step S244 are performed. The trajectory re-planning step S243 is performed to re-plan the travel path of the first vehicle 110 to generate the second travel trajectory according to the first travel trajectory 423 and the temporary stop station message 714. There is the trajectory difference 431 between the second travel trajectory and the first travel trajectory 423. The time-out confirmation step S244 is performed to confirm whether the one-time travel increasing time of the first vehicle 110 caused by the trajectory difference 431 is greater than the one-time upper limit 426 capable of increasing time, and confirm whether the total travel increasing time of the first vehicle 110 caused by the trajectory difference 431 is greater than the maximum upper limit 424 capable of increasing time, thereby generating the time-out confirmation result. The time-out confirmation result is yes (i.e., the one-time travel increasing time (7 minutes) is greater than the one-time upper limit 426 capable of increasing time (3 minutes)). In response to determining that the time-out confirmation result is yes, the new stop station rejecting step S242 and the dispatch vehicle confirmation step S246 are performed, and the stop station updating step S245 is not performed. The new stop station rejecting step S242 is performed to reject the request of the new stop station; in other words, the first vehicle 110 is still moved along the first travel trajectory 423. The dispatch vehicle confirmation step S246 is performed to confirm whether there is the second vehicle 120 that is capable of being dispatched, and then generate the dispatch vehicle confirmation result. In this example, the reserved vehicle number 415 is 1, so that the dispatch vehicle confirmation result is yes, and the dispatch message represents the dispatch operation (Dispatching). The dispatch vehicle number set 140 is generated, and the second vehicle 120 is dispatched to the stop station of the user terminal 700.

In a third example of the non-fixed vehicle dispatch, it is assumed that the first vehicle 110 is originally moved along the first travel trajectory 423. For the dispatch parameter set 410b, the passenger getting on vehicle number 413 of the intelligent bus shelter 600a is 5; the passenger getting on vehicle number 413 of the intelligent bus shelter 600b is 6; the passenger getting on vehicle number 413 of the intelligent bus shelter 600c is 3; and the remaining parameters of the dispatch parameter set 410b are the same as the remaining parameters of the dispatch parameter set 410b of the first example. The temporary passenger getting on vehicle number 712 of the temporary car-hailing order message 710 is 4, and the temporary stop station message 714 corresponds to the location of the user terminal 700. The one-time travel increasing time and the total travel increasing time are both 2 minutes. Under the conditions of the above-mentioned dispatch parameter set 410b, the temporary car-hailing order message 710 and travel increasing times, in the non-fixed vehicle dispatching algorithm S24, the overload confirmation step S241 is performed to confirm whether the sum of the temporary passenger getting on vehicle number 712 and the passenger getting on vehicle number 413 is greater than the maximum passenger number 411 of the first vehicle 110, and then generate the overload confirmation result. The overload confirmation result is yes (i.e., the sum (18 passengers) of the temporary passenger getting on vehicle number 712 (4 passengers) and the passenger getting on vehicle number 413 (14 passengers) at all of the intelligent bus shelters 600a, 600b, 600c is greater than the maximum passenger number 411 (15 passengers)). In response to determining that the overload confirmation result is yes, the new stop station rejecting step S242 and dispatch vehicle confirmation step S246 are performed, and the trajectory re-planning step S243, the time-out confirmation step S244 and the stop station updating step S245 are not performed. The new stop station rejecting step S242 is performed to reject the request of the new stop station; in other words, the first vehicle 110 is still moved along the first travel trajectory 423. The dispatch vehicle confirmation step S246 is performed to confirm whether there is the second vehicle 120 that is capable of being dispatched, and then generate the dispatch vehicle confirmation result. In this example, the reserved vehicle number 415 is 1, so that the dispatch vehicle confirmation result is yes, and the dispatch message represents the dispatch operation (Dispatching). The dispatch vehicle number set 140 is generated, and the second vehicle 120 is dispatched to the stop station of the user terminal 700.

Therefore, the deciding system 100 for stopping and dispatching the vehicles and the deciding method S0 thereof of the present disclosure can be applied to the non-fixed route transportation and can intelligently switch the business mode 417 according to the transportation demand of the passengers. Moreover, the present disclosure can adjust the flow of the passengers of each vehicle and each stop station to achieve the maximum carrying capacity, and can effectively reduce the waiting time of the passengers on each route by dispatching.

In one embodiment, each of the first vehicle processing unit 200, the second vehicle processing unit 300 and the cloud processing unit 500 may be a processor, a microprocessor, an electronic control unit (ECU), a computer, a mobile device, a cloud processor or another computing processor, but the present disclosure is not limited thereto. The memory 400 may be a random-access memory (RAM) or another type of dynamic storage device that stores information, messages and instructions for execution by the cloud processing unit 500, but the present disclosure is not limited thereto. In addition, the user terminal 700 may be a mobile phone or a mobile device. The deciding system 100 for stopping and dispatching the vehicles and the deciding method S0 thereof of the present disclosure can be applied to the transportation of goods (articles).

According to the aforementioned embodiments and examples, the advantages of the present disclosure are described as follows.

1. The deciding system for stopping and dispatching the vehicles and the deciding method thereof of the present disclosure can be applied to the fixed route transportation or the non-fixed route transportation and can adjust the flow of the passengers of each vehicle and each stop station to achieve the maximum carrying capacity. Moreover, the present disclosure can effectively reduce the waiting time of the passengers on each route by dispatching.

2. The deciding system for stopping and dispatching the vehicles and the deciding method thereof of the present disclosure can intelligently switch the business mode according to the transportation demand of the passengers or goods so as to realize the optimal dynamic scheduling of multiple vehicles, and solve the problem of conventional transportation which is easy to cause a lot of waiting time and spends extra time due to overlapping trajectories.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A deciding system for stopping and dispatching vehicles, which is configured to decide stopping and dispatching of the vehicles, the vehicles comprise a first vehicle and a second vehicle, and the deciding system for stopping and dispatching the vehicles comprising:
a first vehicle processing unit disposed on the first vehicle;
a second vehicle processing unit disposed on the second vehicle;
a memory storing a dispatch parameter set; and
a cloud processing unit signally connected to the first vehicle processing unit, the second vehicle processing unit and the memory, wherein the cloud processing unit receives the dispatch parameter set and is configured to perform a deciding method for stopping and dispatching the vehicles, and the deciding method for stopping and dispatching the vehicles comprises:
performing an algorithm deciding step to determine one of a fixed vehicle dispatching algorithm and a non-fixed vehicle dispatching algorithm to be executed by the cloud processing unit according to a temporary car-hailing order message;
performing a vehicle stop deciding step to execute the one of the fixed vehicle dispatching algorithm and the non-fixed vehicle dispatching algorithm to generate a stop message corresponding to a stop station according to the dispatch parameter set, and generate a stop number set corresponding to the first vehicle according to the stop message;
performing a vehicle dispatch deciding step to execute the one of the fixed vehicle dispatching algorithm and the non-fixed vehicle dispatching algorithm to generate a dispatch message according to the dispatch parameter set, and generate a dispatch vehicle number set corresponding to the second vehicle according to the dispatch message; and
performing a message transmitting step to transmit the stop number set and the dispatch vehicle number set to the first vehicle processing unit and the second vehicle processing unit, respectively.

2. The deciding system for stopping and dispatching the vehicles of claim 1, wherein the second vehicle processing unit controls displacement of the second vehicle according to the dispatch vehicle number set, thereby dispatching the second vehicle to the stop station.

3. The deciding system for stopping and dispatching the vehicles of claim 1, wherein,
the dispatch parameter set comprises a maximum passenger number, a vehicle passenger number, a passenger getting on vehicle number and a passenger getting off vehicle number; and
the fixed vehicle dispatching algorithm comprises:
performing a remaining seat confirmation step to confirm whether the vehicle passenger number is greater than or equal to the maximum passenger number, and then generate a first confirmation result;
performing a passenger boarding confirmation step to confirm whether there is at least one passenger getting on at a next stop station where the first vehicle is located, and then generate a second confirmation result;
performing a passenger alighting confirmation step to confirm whether there is the at least one passenger getting off at the next stop station where the first vehicle is located, and then generate a third confirmation result; and
performing a vehicle overload confirmation step to confirm whether the vehicle passenger number minus the passenger getting off vehicle number plus the passenger getting on vehicle number is greater than the maximum passenger number, and then generate a fourth confirmation result;
wherein the stop message and the dispatch message are determined according to at least three of the first confirmation result, the second confirmation result, the third confirmation result and the fourth confirmation result.

4. The deciding system for stopping and dispatching the vehicles of claim 3, wherein,
in response to determining that the first confirmation result is yes, the second confirmation result is yes, the third confirmation result is yes and the fourth confirmation result is yes, the stop message and the dispatch message represent a stop operation and a dispatch operation, respectively;
in response to determining that the first confirmation result is yes, the second confirmation result is yes, the third confirmation result is yes and the fourth confirmation result is no, the stop message and the dispatch message represent the stop operation and a non-dispatch operation, respectively;
in response to determining that the first confirmation result is yes, the second confirmation result is yes and the third confirmation result is no, the stop message and the dispatch message represent a non-stop operation and the dispatch operation, respectively;
in response to determining that the first confirmation result is yes, the second confirmation result is no and the third confirmation result is yes, the stop message and the dispatch message represent the stop operation and the non-dispatch operation, respectively; and
in response to determining that the first confirmation result is yes, the second confirmation result is no and the third confirmation result is no, the stop message and the dispatch message represent the non-stop operation and the non-dispatch operation, respectively.

5. The deciding system for stopping and dispatching the vehicles of claim 3, wherein,
in response to determining that the first confirmation result is no, the second confirmation result is yes, the third confirmation result is yes and the fourth confirmation result is yes, the stop message and the dispatch message represent a stop operation and a dispatch operation, respectively;
in response to determining that the first confirmation result is no, the second confirmation result is yes, the third confirmation result is yes and the fourth confirmation result is no, the stop message and the dispatch message represent the stop operation and a non-dispatch operation, respectively;
in response to determining that the first confirmation result is no, the second confirmation result is yes, the third confirmation result is no and the fourth confirmation result is yes, the stop message and the dispatch message represent the stop operation and the dispatch operation, respectively;
in response to determining that the first confirmation result is no, the second confirmation result is yes, the third confirmation result is no and the fourth confirmation result is no, the stop message and the dispatch message represent the stop operation and the non-dispatch operation, respectively;
in response to determining that the first confirmation result is no, the second confirmation result is no and the third confirmation result is yes, the stop message and the dispatch message represent the stop operation and the non-dispatch operation, respectively; and
in response to determining that the first confirmation result is no, the second confirmation result is no and the third confirmation result is no, the stop message and the dispatch message represent a non-stop operation and the non-dispatch operation, respectively.

6. The deciding system for stopping and dispatching the vehicles of claim 1, wherein,
the dispatch parameter set comprises a first travel trajectory, a passenger getting on vehicle number, a maximum passenger number, a one-time upper limit capable of increasing time and a maximum upper limit capable of increasing time;
the temporary car-hailing order message comprises at least one temporary passenger getting on vehicle number and at least one temporary stop station message, and the first vehicle is moved according to the first travel trajectory; and
in response to determining that the cloud processing unit receives the temporary car-hailing order message from a user terminal, the one of the fixed vehicle dispatching algorithm and the non-fixed vehicle dispatching algorithm is the non-fixed vehicle dispatching algorithm, and the non-fixed vehicle dispatching algorithm comprises:
performing an overload confirmation step to confirm whether a sum of the at least one temporary passenger getting on vehicle number and the passenger getting on vehicle number is greater than the maximum passenger number of the first vehicle, and then generate an overload confirmation result;
performing a new stop station rejecting step to reject a request of a new stop station;
performing a trajectory re-planning step to re-plan a travel path of the first vehicle to generate a second travel trajectory according to the first travel trajectory and at least one temporary stop station message, wherein there is a trajectory difference between the second travel trajectory and the first travel trajectory; and
performing a time-out confirmation step to confirm whether a one-time travel increasing time of the first vehicle caused by the trajectory difference is greater than the one-time upper limit capable of increasing time, and confirm whether a total travel increasing time of the first vehicle caused by the trajectory difference is greater than the maximum upper limit capable of increasing time, thereby generating a time-out confirmation result.

7. The deciding system for stopping and dispatching the vehicles of claim 6, wherein the non-fixed vehicle dispatching algorithm further comprises:
performing a stop station updating step to update the stop station to generate an updated stop station according to the at least one temporary stop station message, and generate the stop number set, so that the updated stop station corresponds to the second travel trajectory;
wherein in response to determining that the overload confirmation result is no and the time-out confirmation result is no, the stop station updating step is performed;
wherein in response to determining that the overload confirmation result is yes, the new stop station rejecting step is performed;
wherein in response to determining that the overload confirmation result is no and the time-out confirmation result is yes, the new stop station rejecting step is performed.

8. The deciding system for stopping and dispatching the vehicles of claim 6, wherein the non-fixed vehicle dispatching algorithm further comprises:
performing a dispatch vehicle confirmation step to confirm whether there is the second vehicle that is capable of being dispatched, and then generate a dispatch vehicle confirmation result;
wherein in response to determining that the dispatch vehicle confirmation result is yes, the dispatch message represents a dispatch operation, and the dispatch vehicle number set is generated;
wherein in response to determining that the dispatch vehicle confirmation result is no, the dispatch message represents a non-dispatch operation and is transmitted to the user terminal.

9. The deciding system for stopping and dispatching the vehicles of claim 1, wherein in the algorithm deciding step,
before the cloud processing unit receives the temporary car-hailing order message, the one of the fixed vehicle dispatching algorithm and the non-fixed vehicle dispatching algorithm is the fixed vehicle dispatching algorithm; and
after the cloud processing unit receives the temporary car-hailing order message, the one of the fixed vehicle dispatching algorithm and the non-fixed vehicle dispatching algorithm is switched from the fixed vehicle dispatching algorithm to the non-fixed vehicle dispatching algorithm.

10. The deciding system for stopping and dispatching the vehicles of claim 1, further comprising:
an intelligent bus shelter signally connected to the cloud processing unit and located at the stop station, wherein the intelligent bus shelter is configured to detect a passenger getting on vehicle number of the dispatch parameter set and transmit the passenger getting on vehicle number to the cloud processing unit; and
a user terminal signally connected to the cloud processing unit and having an application program, wherein the application program is configured to generate the temporary car-hailing order message and transmit the temporary car-hailing order message to the cloud processing unit.

11. A deciding method for stopping and dispatching vehicles, which is configured to decide stopping and dispatching of the vehicles, the vehicles comprise a first vehicle and a second vehicle, and the deciding method for stopping and dispatching the vehicles comprising:
performing an algorithm deciding step to configure a cloud processing unit to determine one of a fixed vehicle dispatching algorithm and a non-fixed vehicle dispatching algorithm to be executed by the cloud processing unit according to a temporary car-hailing order message;
performing a vehicle stop deciding step to configure the cloud processing unit to execute the one of the fixed vehicle dispatching algorithm and the non-fixed vehicle dispatching algorithm to generate a stop message corresponding to a stop station according to a dispatch parameter set from a memory, and generate a stop number set corresponding to the first vehicle according to the stop message;
performing a vehicle dispatch deciding step to configure the cloud processing unit to execute the one of the fixed vehicle dispatching algorithm and the non-fixed vehicle dispatching algorithm to generate a dispatch message according to the dispatch parameter set, and generate a dispatch vehicle number set corresponding to the second vehicle according to the dispatch message; and
performing a message transmitting step to configure the cloud processing unit to transmit the stop number set and the dispatch vehicle number set to a first vehicle processing unit and a second vehicle processing unit, respectively;
wherein the first vehicle processing unit is disposed on the first vehicle, and the second vehicle processing unit is disposed on the second vehicle.

12. The deciding method for stopping and dispatching the vehicles of claim 11, wherein the second vehicle processing unit controls displacement of the second vehicle according to the dispatch vehicle number set, thereby dispatching the second vehicle to the stop station.

13. The deciding method for stopping and dispatching the vehicles of claim 11, wherein,
the dispatch parameter set comprises a maximum passenger number, a vehicle passenger number, a passenger getting on vehicle number and a passenger getting off vehicle number; and
the fixed vehicle dispatching algorithm comprises:
performing a remaining seat confirmation step to confirm whether the vehicle passenger number is greater than or equal to the maximum passenger number, and then generate a first confirmation result;
performing a passenger boarding confirmation step to confirm whether there is at least one passenger getting on at a next stop station where the first vehicle is located, and then generate a second confirmation result;
performing a passenger alighting confirmation step to confirm whether there is the at least one passenger getting off at the next stop station where the first vehicle is located, and then generate a third confirmation result; and
performing a vehicle overload confirmation step to confirm whether the vehicle passenger number minus the passenger getting off vehicle number plus the passenger getting on vehicle number is greater than the maximum passenger number, and then generate a fourth confirmation result;
wherein the stop message and the dispatch message are determined according to at least three of the first confirmation result, the second confirmation result, the third confirmation result and the fourth confirmation result.

14. The deciding method for stopping and dispatching the vehicles of claim 13, wherein,
in response to determining that the first confirmation result is yes, the second confirmation result is yes, the third confirmation result is yes and the fourth confirmation result is yes, the stop message and the dispatch message represent a stop operation and a dispatch operation, respectively;
in response to determining that the first confirmation result is yes, the second confirmation result is yes, the third confirmation result is yes and the fourth confirmation result is no, the stop message and the dispatch message represent the stop operation and a non-dispatch operation, respectively;
in response to determining that the first confirmation result is yes, the second confirmation result is yes and the third confirmation result is no, the stop message and the dispatch message represent a non-stop operation and the dispatch operation, respectively;
in response to determining that the first confirmation result is yes, the second confirmation result is no and the third confirmation result is yes, the stop message and the dispatch message represent the stop operation and the non-dispatch operation, respectively; and
in response to determining that the first confirmation result is yes, the second confirmation result is no and the third confirmation result is no, the stop message and the dispatch message represent the non-stop operation and the non-dispatch operation, respectively.

15. The deciding method for stopping and dispatching the vehicles of claim 13, wherein,
in response to determining that the first confirmation result is no, the second confirmation result is yes, the third confirmation result is yes and the fourth confirmation result is yes, the stop message and the dispatch message represent a stop operation and a dispatch operation, respectively;
in response to determining that the first confirmation result is no, the second confirmation result is yes, the third confirmation result is yes and the fourth confirmation result is no, the stop message and the dispatch message represent the stop operation and a non-dispatch operation, respectively;
in response to determining that the first confirmation result is no, the second confirmation result is yes, the third confirmation result is no and the fourth confirmation result is yes, the stop message and the dispatch message represent the stop operation and the dispatch operation, respectively;
in response to determining that the first confirmation result is no, the second confirmation result is yes, the third confirmation result is no and the fourth confirmation result is no, the stop message and the dispatch message represent the stop operation and the non-dispatch operation, respectively;
in response to determining that the first confirmation result is no, the second confirmation result is no and the third confirmation result is yes, the stop message and the dispatch message represent the stop operation and the non-dispatch operation, respectively; and
in response to determining that the first confirmation result is no, the second confirmation result is no and the third confirmation result is no, the stop message and the dispatch message represent a non-stop operation and the non-dispatch operation, respectively.

16. The deciding method for stopping and dispatching the vehicles of claim 11, wherein,
the dispatch parameter set comprises a first travel trajectory, a passenger getting on vehicle number, a maximum passenger number, a one-time upper limit capable of increasing time and a maximum upper limit capable of increasing time;
the temporary car-hailing order message comprises at least one temporary passenger getting on vehicle number and at least one temporary stop station message, and the first vehicle is moved according to the first travel trajectory; and
in response to determining that the cloud processing unit receives the temporary car-hailing order message from a user terminal, the one of the fixed vehicle dispatching algorithm and the non-fixed vehicle dispatching algorithm is the non-fixed vehicle dispatching algorithm, and the non-fixed vehicle dispatching algorithm comprises:
performing an overload confirmation step to confirm whether a sum of the at least one temporary passenger getting on vehicle number and the passenger getting on vehicle number is greater than the maximum passenger number of the first vehicle, and then generate an overload confirmation result;
performing a new stop station rejecting step to reject a request of a new stop station;
performing a trajectory re-planning step to re-plan a travel path of the first vehicle to generate a second travel trajectory according to the first travel trajectory and at least one temporary stop station message, wherein there is a trajectory difference between the second travel trajectory and the first travel trajectory; and
performing a time-out confirmation step to confirm whether a one-time travel increasing time of the first vehicle caused by the trajectory difference is greater than the one-time upper limit capable of increasing time, and confirm whether a total travel increasing time of the first vehicle caused by the trajectory difference is greater than the maximum upper limit capable of increasing time, thereby generating a time-out confirmation result.

17. The deciding method for stopping and dispatching the vehicles of claim 16, wherein the non-fixed vehicle dispatching algorithm further comprises:
performing a stop station updating step to update the stop station to generate an updated stop station according to the at least one temporary stop station message, and generate the stop number set, so that the updated stop station corresponds to the second travel trajectory;
wherein in response to determining that the overload confirmation result is no and the time-out confirmation result is no, the stop station updating step is performed;
wherein in response to determining that the overload confirmation result is yes, the new stop station rejecting step is performed;
wherein in response to determining that the overload confirmation result is no and the time-out confirmation result is yes, the new stop station rejecting step is performed.

18. The deciding method for stopping and dispatching the vehicles of claim 16, wherein the non-fixed vehicle dispatching algorithm further comprises:
performing a dispatch vehicle confirmation step to confirm whether there is the second vehicle that is capable of being dispatched, and then generate a dispatch vehicle confirmation result;
wherein in response to determining that the dispatch vehicle confirmation result is yes, the dispatch message represents a dispatch operation, and the dispatch vehicle number set is generated;
wherein in response to determining that the dispatch vehicle confirmation result is no, the dispatch message represents a non-dispatch operation and is transmitted to the user terminal.

19. The deciding method for stopping and dispatching the vehicles of claim 11, wherein in the algorithm deciding step,
before the cloud processing unit receives the temporary car-hailing order message, the one of the fixed vehicle dispatching algorithm and the non-fixed vehicle dispatching algorithm is the fixed vehicle dispatching algorithm; and
after the cloud processing unit receives the temporary car-hailing order message, the one of the fixed vehicle dispatching algorithm and the non-fixed vehicle dispatching algorithm is switched from the fixed vehicle dispatching algorithm to the non-fixed vehicle dispatching algorithm.
